(19) United States
(12) Patent Application Publication
(10) Pub. No.: US 2026/0234172 A1
(43) Pub. Date: Aug. 13, 2026

(54) A PROCESS FOR PREPARATION OF GLUFOSINATE OR ISOMER OR SALT THEREOF

(71) Applicant: UPL LIMITED, Mumbai (IN)

(72) Inventors: Rushikumar Patel, Mumbai (IN); Chetan Virbhan Borse, Mumbai (IN); Prashant Kini, Mumbai (IN); Ashishkumar Ravindra Mishra, Mumbai (IN); Mukesh Deshmukh, Mumbai (IN)

(73) Assignee: UPL LIMITED, Mumbai (IN)

(21) Appl. No.: 19/155,295

(22) PCT Filed: Feb. 15, 2024
(86) PCT No.: PCT/IB2024/051416

§ 371 Date: Aug. 11, 2025

(30) Foreign Application Priority Data
Feb. 15, 2023 (IN) 202321009983

(51) Int. Cl. C07F 9/30; A01N 57/20; A01P 13/00; C07F 9/02

(52) U.S. Cl. CPC C07F 9/301; A01N 57/20; A01P 13/00; C07F 9/025

(57) ABSTRACT

The present invention relates to a process for preparation of glufosinate ammonium, the process comprises of processing a first solution comprising of glufosinate and inorganic salts through a membrane; and precipitating glufosinate ammonium from said second.

### FILED OF THE INVENTION

The present invention relates to a process for preparation of glufosinate ammonium and particularly the process relates to preparation of glufosinate ammonium that is substantially free of inorganic salts.

### BACKGROUND OF THE INVENTION

Glufosinate-ammonium is used for control of a wide range of annual and perennial broad-leaved weeds and grasses in fruit orchards, vineyards, rubber and oil palm plantations, ornamental trees and bushes, non-crop land, and pre-emergence in vegetables. Also used as a desiccant in crops such as potatoes, sunflowers. It can also control annual and perennial weeds and grasses in glufosinate-tolerant crops such as oilseed rape, maize, soya beans and sugar beet which are developed through gene technology. It acts as glutamine synthetase inhibitor and leads to accumulation of ammonia, which leads to inhibition of photosynthesis. Glufosinate ammonium is one of the widely used non-selective contact herbicide. Translocation occurs only within leaves, predominantly from the leaf base to the leaf tip.

Well known process for the preparation of glufosinate ammonium as disclosed in U.S. Pat. No. 4,264,532 involves Strecker synthesis of α-aminonitriles from the corresponding aldehyde using ammonium chloride/ammonia and sodium cyanide or alternatively with mixtures of ammonia and hydrocyanic acid. α-Aminonitriles are further subjected to acid or base hydrolysis to obtain Glufosinate ammonium (Scheme 1).

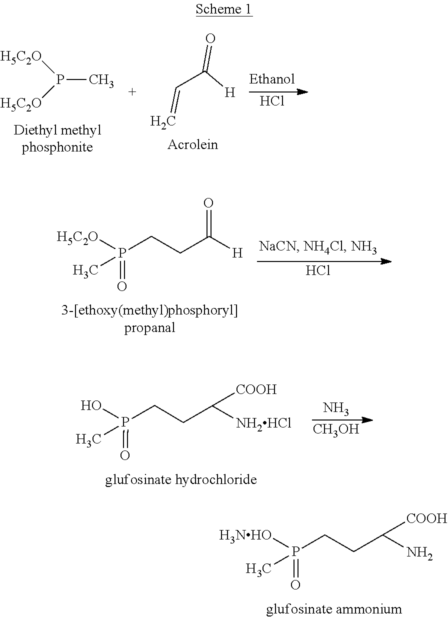

It has been noted that during the process along with glufosinate ammonium, huge amount of inorganic salts are generated, separation of which is difficult by conventional methods as the solubility of both the salts are high in water. Large amounts of solvents and water is required for purification which makes the process cumbersome, hazardous practices and expensive.

U.S. Pat. No. 6,359,162 discloses that glufosinate ammonium can be separated from the inorganic salts by recrystallisation from methanol. However, such simple recrystallisation method failed to separate inorganic salts efficiently resulting in low quality product.

CN102268037A discloses a method to purify glufosinate ammonium from the reaction mixture by subjecting the glufosinate hydrochloride to esterification reaction by treatment with methanol to get the corresponding methyl ester, separating the inorganics by filtration, hydrolysing it back to glufosinate hydrochloride and then converting it into glufosinate ammonium by treatment with aqueous ammonia (Scheme 2).

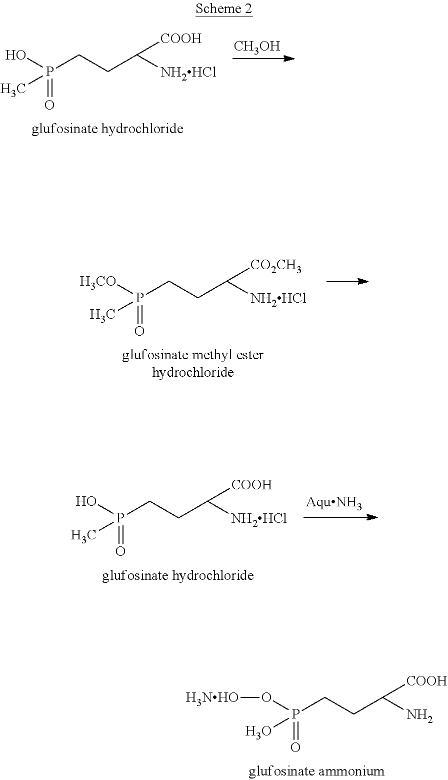

However, the method is tedious, involves multiple filtrations, acidification and crystallisation steps and generates huge amount of effluents.

Therefore, there exists a need to develop robust purification method to obtain high quality glufosinate ammonium avoiding multiple purification steps.

### OBJECTS OF THE INVENTION

An object of the present invention is to provide an industrially viable, environmentally friendly process for preparation of glufosinate or isomer or salt thereof free from inorganic salts.

Another object of the present invention is to provide a process for preparation of glufosinate ammonium avoiding multiple purification steps.

Another object of the present invention is to provide a process for preparation of glufosinate ammonium containing less than 3% by weight of inorganic salts.

Another object of the present invention is to provide a process for preparation of L-glufosinate ammonium containing less than 3% by weight of inorganic salts.

### SUMMARY OF THE INVENTION

In an aspect of the present invention, there is provided a process for preparing glufosinate or isomer or salt thereof.

In an aspect of the present invention, there is provided a process for preparing glufosinate ammonium having less than 3% by weight of inorganic salts, said process comprising precipitating glufosinate ammonium by treating a solution comprising glufosinate ammonium with ammonia, said solution comprising glufosinate ammonium being prepared by passing a first solution comprising glufosinate and inorganic salts through a membrane.

In an embodiment, passing a first solution comprising glufosinate and inorganic salts through a membrane results into the solution comprising glufosinate ammonium that is treatable with ammonia; and a permeate.

In an aspect, there is provided a process for preparing glufosinate ammonium having less than 3% by weight of inorganic salts, said process comprising precipitating glufosinate ammonium by treating a solution comprising glufosinate with ammonia, said solution comprising glufosinate being prepared by passing a first solution comprising glufosinate and inorganic salts through a membrane.

In another aspect of the present invention, there is provided a process for preparing glufosinate ammonium comprising:
a) processing a first solution comprising glufosinate and inorganic salts through a membrane to obtain a second solution and a permeate; and
b) precipitating glufosinate ammonium from said second solution by ammonia treatment; wherein said glufosinate ammonium contains less than 3% by weight of inorganic salts.

In another aspect of the present invention, there is provided a process for preparing L-glufosinate ammonium comprising:
a) processing a first solution comprising L-glufosinate and inorganic salts through a membrane to obtain a second solution and a permeate; and
b) precipitating L-glufosinate ammonium from said second solution by a treatment comprising ammonia; wherein said L-glufosinate ammonium contains less than 3% by weight of inorganic salts.

In another aspect of the present invention, there is provided a process for preparing glufosinate ammonium comprising the steps of:
a) preparing a first solution comprising glufosinate and inorganic salts having total dissolved solute content below 15%.
b) processing said first solution through a membrane to obtain a second solution and permeate; and
c) precipitating glufosinate ammonium from said second solution by ammonia treatment;
   wherein said glufosinate ammonium contains less than 3% by weight of inorganic salts.

In yet another aspect of the present invention, there is provided a process for preparing L-glufosinate ammonium comprising the steps of:
a) preparing a first solution comprising L-glufosinate and inorganic salts having total dissolved solute content below 15%
b) processing said first solution through a membrane to obtain a second solution and permeate; and
c) precipitating L-glufosinate ammonium from said second solution by a treatment with gaseous ammonia and methanol;
   wherein said L-glufosinate ammonium contains less than 3% by weight of inorganic salts.

In another aspect, the present disclosure provides a herbicide composition comprising glufosinate ammonium or L-glufosinate ammonium having less than 3% by weight of an inorganic salt and at least one agrochemically acceptable excipient.

### DETAILED DESCRIPTION OF THE INVENTION

Those skilled in art will be aware that invention described herein is subject to variations and modifications other than those specifically described. It is to be understood that the invention described herein includes all such variations and modifications. The invention also includes all such steps, features, compositions and methods referred to or indicated in this specification, individually or collectively, and any and all combinations of any two or more said steps or features.

### Definitions

For convenience, before further description of the present invention, certain terms employed in the specification, examples are described here. These definitions should be read in light of the remainder of the disclosure and understood as by a person of skill in the art. Unless defined otherwise, all technical and scientific terms used herein have the same meaning as commonly understood by a person of ordinary skill in the art. The terms used throughout this specification are defined as follows, unless otherwise limited in specific instances.

The terms used herein are defined as follows.

The term “purity” means purity as determined by HPLC (“High Pressure Liquid Chromatography”).

As used herein, the term “essentially pure,” “pure,” or “high purity” means that the purity of such material is at least 95%.

The term “about” or “approximately” as used herein is inclusive of the stated value and means within an acceptable range of deviation for particular value as determined by one of ordinary skill in the art, considering the measurement in question and the error associated with measurement of the particular quantity (i.e., the limitations of the measurement system). For example, “about” can mean within one or more standard deviations, or within +10 or +5 of the stated value. Recitation of ranges of values are merely intended to serve as a shorthand method of referring individually to each separate value falling within the range, unless otherwise indicated herein, and each separate value is incorporated into the specification as if it were individually recited herein. The endpoints of all ranges are included within the range and independently combinable. It is understood that where a parameter range is provided, all integers within that range, and tenths thereof, are also provided. For example, “0.1-80%” includes 0.1%, 0.2%, 0.3%, etc. up to 80%

As used herein, the terms “comprising” “including,” “having,” “containing,” “involving,” and the like are to be understood to be open-ended, i.e., to mean including but not limited to.

The terms “preferred” and “preferably” refer to embodiments of the invention that may afford certain benefits, under certain circumstances. In an embodiment, the aspects and embodiments described herein shall also be interpreted to replace the clause “comprising” with either “consisting of” or with “consisting essentially of” or with “consisting substantially of”.

The term “glufosinate” as used herein shall be taken to mean racemic glufosinate acid, L-glufosinate acid, D-glufosinate acid or a mixture of L-glufosinate acid and D-glufosinate acid, wherein the ratio of L-isomer to D-isomer is in the range of 1:99 to 99:1

The term “glufosinate ammonium” as used herein shall be taken to mean ammonium salt of racemic glufosinate acid, L-glufosinate acid, D-glufosinate acid or a mixture of L-glufosinate acid and D-glufosinate acid, wherein the ratio of L-isomer to D-isomer is in the range of 1:99 to 99:1.

The term “glufosinate hydrochloride” as used herein shall be taken to mean hydrochloride salt of racemic glufosinate acid, L-glufosinate acid, D-glufosinate acid or a mixture of L-glufosinate acid and D-glufosinate acid, wherein the ratio of L-isomer to D-isomer is in the range of 1:99 to 99:1.

The term “L-glufosinate” as used herein is a L-isomer of glufosinate and the meaning is inclusive of glufosinate or salts thereof having isomeric purity of more than 90%.

The term “nanofiltration” as used herein shall be taken to mean a synthetic membrane that provides a nominal molecular weight cut-off in the range 100 unit Da to 200 unit Da.

The term “feed” as used herein means and shall be used interchangeably throughout the disclosure as the first solution comprising glufosinate and inorganic salts that enters the nanofiltration membrane.

The term “permeate” as used herein shall be taken to mean the fluid that passes through the membrane and having high contents of inorganic salts.

The term “concentrate” as used herein means and shall be used interchangeably throughout the disclosure, as the second solution that contains the glufosinate substantially free of inorganic salt.

The term “glufosinate ammonium substantially free of inorganic salts or L-glufosinate ammonium substantially free of inorganic salts” means glufosinate ammonium or L-glufosinate ammonium as defined above, containing less than 3% of inorganic salts, preferably less than 2%.

The term “Total dissolved solute” is a measure of the dissolved combined content of all inorganic and organic substances present in a liquid in molecular, ionized, or micro-granular suspended form. The term “Total dissolved solute” and (TDS) shall be used interchangeably throughout the disclosure.

Inventors of the present invention developed a process for the preparation of glufosinate ammonium wherein the process comprises effective separation of inorganic salts during the process thereby avoiding subsequent purification processes such as esterification. The advantageous process leads to higher purity of the product, reduces solvent use and effluent generation, and is cost effective.

Exemplary embodiments in accordance with the present invention will be described herein below. Various modifications, adaptations or variations of such exemplary embodiments may become apparent to those skilled in the art as such embodiments are disclosed. It will be understood that all such modifications, adaptations or variations that rely upon the teachings of the present invention are considered to be within the scope of the present invention.

Thus, in an aspect of the present invention, there is provided a process for preparing glufosinate ammonium having less than 3% by weight of inorganic salts, said process comprising precipitating glufosinate ammonium by treating a solution comprising glufosinate ammonium with ammonia, said solution comprising glufosinate ammonium being prepared by passing a first solution comprising glufosinate and inorganic salts through a membrane.

In an embodiment, passing a first solution comprising glufosinate and inorganic salts through a membrane results into the solution comprising glufosinate ammonium that is treatable with ammonia; and a permeate.

In an aspect, there is provided a process for preparing glufosinate ammonium having less than 3% by weight of inorganic salts, said process comprising precipitating glufosinate ammonium by treating a solution comprising glufosinate with ammonia, said solution comprising glufosinate being prepared by passing a first solution comprising glufosinate and inorganic salts through a membrane.

In another aspect of the present invention, there is provided a process for preparing glufosinate ammonium comprising:
a) processing a first solution comprising glufosinate and inorganic salts through a membrane to obtain a second solution and a permeate; and
b) precipitating glufosinate ammonium from said second solution by a treatment comprising ammonia; wherein said glufosinate ammonium contains less than 3% by weight of inorganic salts.

In an embodiment, in the step a) the glufosinate used is racemic glufosinate acid or L-glufosinate acid.

In an embodiment, the first solution comprising glufosinate and inorganic salts, is obtained from a hydrolysed reaction mass comprising glufosinate hydrochloride and inorganic salts.

The hydrolysed reaction mass comprising glufosinate hydrochloride and inorganic salts is either alkaline hydrolysed reaction mass or acid hydrolysed reaction mass.

In an embodiment, the hydrolysed reaction mass comprising glufosinate hydrochloride and inorganic salts is subjected to
i) adjusting the total dissolved solute concentration below 15%; and
ii) adjusting the pH in the range of 6 to 8
   to obtain the first solution comprising glufosinate and inorganic salts.

In an embodiment, in the step i) the total dissolved solute concentration is adjusted by dilution with water.

In another embodiment, the steps i) and ii) are carried out in any sequence.

In another embodiment, there is provided a process for preparation of the first solution comprising glufosinate and inorganic salts comprises steps of
i) adjusting the total dissolved solute concentration below 15% of a hydrolysed reaction mass comprising glufosinate hydrochloride and inorganic salts; and
ii) adjusting the pH of the solution in the range of 6 to 8 to obtain the first solution comprising of glufosinate and inorganic salts

In another embodiment, there is provided a preparation of the first solution comprising of glufosinate and inorganic salts comprises steps of
a) adjusting the pH of a hydrolysed reaction mass comprising glufosinate hydrochloride and inorganic salts, in the range of 6 to 8; and
b) adjusting the total dissolved solute concentration below 15% to obtain the first solution comprising of glufosinate and inorganic salts.

In an embodiment, in the step i) the total dissolved solute concentration is adjusted by diluting hydrolysed reaction mass with water and in step ii) pH value is adjusted using a base.

In another embodiment, the steps of adjustment of the total dissolved solute concentration below 15% and pH adjustment are carried out in any sequence.

In another embodiment, the total dissolved solute concentration is adjusted below 15% by dilution with water.

In another embodiment, the hydrolysed reaction mass comprising glufosinate hydrochloride and inorganic salts, is prepared by reaction of 3-[ethoxy(methyl)phosphoryl]propanal with sodium cyanide and ammonium chloride followed by hydrolysis.

Said reaction can be schematically represented as in scheme 3.

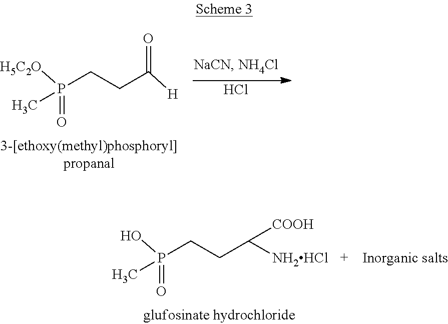

In another embodiment, the hydrolysed reaction mass comprising L-glufosinate hydrochloride and inorganic salts, is obtained by acid hydrolysis of Ethyl(2S)-2-[(ethoxycarbonyl)amino]-4-(ethoxymethylphosphinyl) butanoate. Said reaction can be schematically represented as in scheme 4

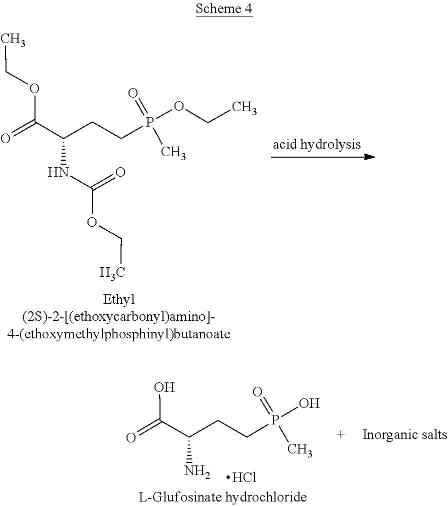 [SMILES: CCOC(=O)N[C@@H](CCP(C)(=O)OCC)C(=O)OCC ; CP(=O)(O)CC[C@H](N)C(=O)O ; Cl]

In yet another embodiment, Ethyl(2S)-2-[(ethoxycarbonyl)amino]-4-(ethoxymethylphosphinyl) butanoate used for preparation of hydrolysed reaction mass can be prepared by methods known in prior art.

One of the methods used for preparation of Ethyl(2S)-2-[(ethoxycarbonyl)amino]-4-(ethoxymethylphosphinyl) butanoate is by reacting ethyl(2S)-4-chloro-2-[(ethoxy carbonyl)amino]-butanoate and diethyl methyl phosphonite, as shown in scheme 5

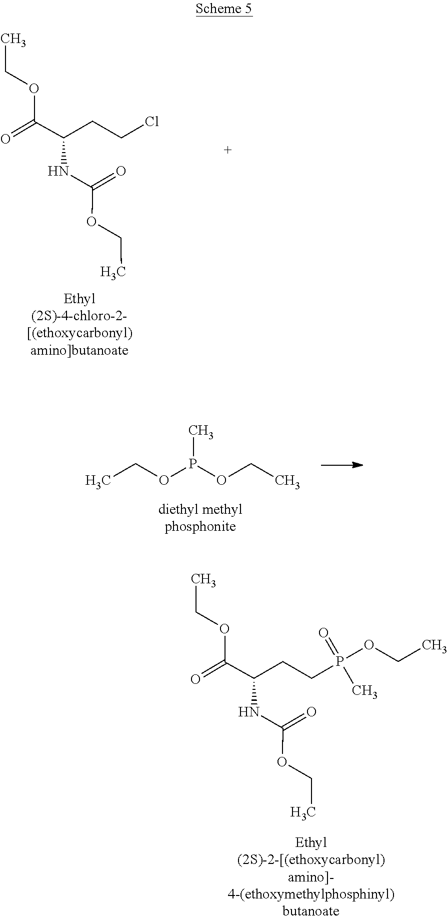

In another embodiment, the total dissolved solute concentration of the hydrolysed reaction mass is adjusted below 15% by dilution with water.

In another embodiment, the total dissolved solute concentration of the hydrolysed reaction mass is adjusted below 10% by dilution with water.

In an embodiment, adjustment in the pH is carried out by treatment with a base.

In an embodiment, the base used is selected from, but not limited to, ammonia, ammonium hydroxide, hydroxides of alkali metal or alkali earth metal, carbonates of alkali metal or alkali earth metal, alcohol salts of alkali metal or alkali earth metal.

In an embodiment, the base used is selected from, but not limited to, ammonia, ammonium hydroxide, lithium hydroxide, sodium hydroxide, potassium hydroxide, cesium hydroxide, lithium carbonate, sodium carbonate, potassium carbonate, cesium carbonate, sodium hydrogen carbonate, potassium hydrogen carbonate, sodium ethoxide, sodium methoxide and the likes.

In an embodiment, the base used is ammonia.

In an embodiment, the base used is aqueous ammonia.

In an embodiment, the base used is gaseous ammonia.

In an embodiment, the inorganic salts such as sodium chloride, potassium chloride, ammonium chloride, lithium chloride and the likes are formed in said process.

In an embodiment, the inorganic salt formed is ammonium chloride.

In an embodiment, the inorganic salt formed is sodium chloride.

In another embodiment, the first solution, may further comprise glufosinate ammonium.

In an embodiment, the first solution comprises from about 1% to about 7% by weight of glufosinate.

In an embodiment, the first solution comprises from about 2% to about 12% by weight of inorganic salts.

In an embodiment, the first solution is processed through a membrane.

In an embodiment, the membrane used in step a) is nano-filtration membrane.

In an embodiment, the nano-filtration membrane is made of polymeric material.

In an embodiment, the membrane used in the process of the present invention may be formed from any polymeric material which provides separating layer capable of fractionating the glufosinate content or separating the desired glufosinate from inorganic salts.

In an embodiment, the polymeric material used is selected from group comprising of, but not limited to, polyethylene, polypropylene, polytet rafluoroethylene (PTFE), polyvinylidene difluoride (PVDF), polysulfone, polyetherSulfone, polyacrylonitrile, polyamide, polyimide, polyamideimide, polyetherimide, cellulose acetate, polyaniline, polypyrrole, polyetheretherketone (PEEK), polybenzimidazole, polyester, vinyl polymer or mixtures thereof.

The membrane used can be made by any technique known in the art, including sintering, stretching, track etching, template leaching, interfacial polymerization, or phase inversion.

In an embodiment, the polymeric material used is polyamide.

In an embodiment, the membrane has molecular weight cut-off in the range of about 100 unit Da to about 200 unit Da.

In an embodiment, the nano-filtration membrane having molecular weight in the range of about 100 unit Da to about 200 unit Da.

In an embodiment, fractionation of the inorganic salts may be achieved through contacting the first solution with membrane that retains the glufosinate i.e. in form of concentrate and allows permeation of the inorganic salts i.e. in form of permeate. Content permeates through the membrane due to a trans-membrane pressure.

In an embodiment, the first solution is processed through a membrane at a trans-membrane pressure ranging from about 3 (g) bar to about 50 (g) bar.

In an embodiment, the second solution comprises less than 6% by weight of inorganic salts based on total weight of second solution.

In an embodiment, the second solution obtained, may be, processed again through the nano-filtration membrane to obtain solution comprising desired weight percentage of inorganic salts.

In another embodiment, the second solution obtained, may be, processed through the nano-filtration membrane multiple times to obtain solution comprising desired weight percentage of inorganic salts.

In an embodiment, in step b) before treatment with ammonia, the second solution is subjected to distillation for removal of water and to obtain a reaction mass.

In an embodiment, about 50% to 95% by weight of water from second solution is removed to obtain a reaction mass.

In an embodiment, the reaction mass is treated with an alcohol at reflux temperature and sequentially treated with ammonia.

In an embodiment, the alcohol used is selected from, but not limited to, C₁-C₅ alcohols.

In an embodiment, the alcohol used is selected from, but not limited to, C₁-C₅ alcohols such as methanol, ethanol, n-propanol, isopropanol and the likes.

In an embodiment, the alcohol used is methanol.

In an embodiment, the volume ratio of the alcohol and the reaction mass is in the range of 0.2:1 to 1:1.

In another embodiment, treatment with ammonia is carried out at temperature ranging from 30° C. to 50° C.

In another embodiment, the treatment is carried out with gaseous ammonia.

In an embodiment, glufosinate ammonium prepared according to the present invention has purity of about or more than 95% by HPLC.

In an embodiment glufosinate ammonium prepared according to the present invention contains less than 3% by weight of inorganic salts, preferably less than 2% by weight of inorganic salts.

In an embodiment glufosinate ammonium obtained in step b) is racemic glufosinate ammonium.

In an embodiment glufosinate ammonium obtained in step b) is L-glufosinate ammonium.

According to another aspect of the present invention, there is provided a process for preparing glufosinate ammonium comprising the steps of:
a) preparing a first solution comprising of glufosinate and inorganic salts having total dissolved solute content below 15%;
b) processing said first solution through a membrane to obtain a second solution and permeate; and
c) precipitating glufosinate ammonium from said second solution by a treatment comprising ammonia; wherein said glufosinate ammonium contains less than 3% by weight of inorganic salts.

In another embodiment, the total dissolved solute concentration of first solution in step a) is adjusted below 15% by dilution with water.

In another embodiment, after adjusting the total dissolved solute concentration of first solution, the solution is subjected to pH adjustment in range of 6 to 8.

The pH adjustment of the first solution is carried out by treatment with a base.

In an embodiment, the base used is selected from, but not limited to, ammonia, ammonium hydroxide, hydroxides of alkali metal or alkali earth metal, carbonates of alkali metal or alkali earth metal, alcohol salts of alkali metal or alkali earth metal.

The base used is selected from, but not limited to, ammonia, ammonium hydroxide, lithium hydroxide, sodium hydroxide, potassium hydroxide, cesium hydroxide, lithium carbonate, sodium carbonate, potassium carbonate, cesium carbonate, sodium hydrogen carbonate, potassium hydrogen carbonate, sodium ethoxide, sodium methoxide and the likes.

In an embodiment, the base used is aqueous ammonia.

In an embodiment, the base used is gaseous ammonia.

In another embodiment, the glufosinate ammonium obtained in step iii) is racemic glufosinate ammonium or L-glufosinate ammonium.

In another embodiment, the glufosinate ammonium obtained in step iii) is racemic glufosinate ammonium.

In an embodiment, racemic glufosinate ammonium obtained is substantially free of inorganic salts.

The racemic glufosinate ammonium obtained contains less than 3% by weight of inorganic salts.

In an embodiment, racemic glufosinate ammonium obtained contains less than 2% by weight of inorganic salts.

In an embodiment, racemic glufosinate ammonium having more than 95% purity is obtained.

In another embodiment, the glufosinate ammonium obtained in step iii) is L-glufosinate ammonium.

In an embodiment, L-glufosinate ammonium obtained is substantially free of inorganic salts.

The L-glufosinate ammonium obtained contains less than 3% by weight of inorganic salts.

In an embodiment, the L-glufosinate ammonium obtained contains less 2% by weight of inorganic salts, preferably less than 1% by weight of inorganic salts, more preferably less than 0.5% by weight of inorganic salts.

In an embodiment, L-glufosinate ammonium produced according to the present process is having more than 95% purity.

According to another aspect of the present invention there is provided a process for preparing glufosinate ammonium comprising the steps of:
a) preparing a first solution comprising of glufosinate and inorganic salts having total dissolved solute content below 15%;
b) processing said first solution through a membrane to obtain a second solution and permeate; and
c) precipitating glufosinate ammonium from said second solution by a treatment with gaseous ammonia and methanol
   wherein said glufosinate ammonium contains less than 3% by weight of inorganic salts.

In another embodiment, the glufosinate ammonium obtained in step iii) is racemic glufosinate ammonium.

According to another aspect of the present invention there is provided a process for preparing L-glufosinate ammonium comprising the steps of:
a) preparing a first solution comprising of L-glufosinate and inorganic salts having total dissolved solute content below 15%;
b) processing said first solution through a membrane to obtain a second solution and permeate; and
c) precipitating L-glufosinate ammonium from said second solution by a treatment with gaseous ammonia and methanol
   wherein said L-glufosinate ammonium contains less than 3% by weight of inorganic salts.

In an embodiment, there is provided a process for preparing L-glufosinate ammonium comprising the steps of:
a) preparing a first solution comprising of L-glufosinate and inorganic salts having total dissolved solute content below 10%;
b) processing said first solution through a membrane to obtain a second solution and permeate; and
c) precipitating L-glufosinate ammonium from said second solution by a treatment with gaseous ammonia and methanol
   wherein said L-glufosinate ammonium contains less than 3% by weight of inorganic salts.

In an aspect of the present invention, there is provided a process for preparing glufosinate salt comprising:
a) processing a first solution comprising of glufosinate and inorganic salts through a membrane to obtain a second solution and a permeate; and
b) preparing glufosinate salt from said second solution by a treatment with a base; wherein said glufosinate salt contains less than 3% by weight of inorganic salts.

In an embodiment, the first solution comprises of may further comprise of glufosinate salt/s such as glufosinate ammonium, glufosinate sodium, glufosinate potassium and so on.

In an embodiment, the first solution comprises of inorganic salts in such as sodium chloride, potassium chloride, ammonium chloride, lithium chloride and the likes.

In an embodiment, the base used is selected from, but not limited to, ammonia, ammonium hydroxide, lithium hydroxide, sodium hydroxide, potassium hydroxide, cesium hydroxide, lithium carbonate, sodium carbonate, potassium carbonate, cesium carbonate, sodium hydrogen carbonate, potassium hydrogen carbonate, sodium ethoxide, sodium methoxide and the likes.

In an embodiment, the glufosinate salt prepared is L-glufosinate salt.

In an embodiment, the present invention provides highly pure glufosinate ammonium or L-glufosinate ammonium.

In an embodiment the present invention provides a purification process for preparing highly pure glufosinate ammonium or L-glufosinate ammonium.

In an embodiment the present purification process comprising
a) passing a first solution comprising glufosinate and inorganic salts through a nanofiltration membrane to obtain a second solution and a permeate; and
b) preparing glufosinate salt from said second solution by treating the second solution with a base; wherein said glufosinate salt contains less than 3% by weight of inorganic salts.

In an embodiment the first solution comprising high content of inorganic salt, preferably more than 3% by weight.

In an embodiment the high content of inorganic salt is reduced below 3% by weight in accordance with the present process for preparing glufosinate salt.

In another aspect of the present invention, there is provided glufosinate ammonium having less than 3% by weight of inorganic salts.

In yet another aspect of the present invention, there is provided L-glufosinate ammonium having less than 3% by weight of inorganic salts.

In an embodiment, the present invention provides a herbicide composition comprising glufosinate ammonium or L-glufosinate ammonium having less than 3% by weight of an inorganic salt and at least one agrochemically acceptable excipient.

The agrochemically acceptable excipient may be any one or a combination of adjuvants, co-solvents, surfactants, colorants, dispersants, emulsifiers, thickeners, antifreeze agents, biocides, anti-foam agents, stabilizers, wetting agents, or a mixture thereof.

Exemplary surfactants include non-ionic, anionic and cationic surfactants.

Examples of nonionic surfactants include polyarylphenol polyethoxy ethers, polyalkylphenol polyethoxy ethers, polyglycol ether derivatives of saturated fatty acids, polyglycol ether derivatives of unsaturated fatty acids, polyglycol ether derivatives of aliphatic alcohols, polyglycol ether derivatives of cycloaliphatic alcohols, fatty acid esters of polyoxyethylene sorbitan, alkoxylated vegetable oils, alkoxylated acetylenic diols, polyalkoxylated alkylphenols, fatty acid alkoxylates, sorbitan alkoxylates, sorbitol esters, C₈-C₂₂ alkyl or alkenyl polyglycosides, polyalkoxy styrylaryl ethers, alkylamine oxides, block copolymer ethers, polyalkoxylated fatty glyceride, polyalkylene glycol ethers, linear aliphatic or aromatic polyesters, organo silicones, polyaryl phenols, sorbitol ester alkoxylates, polyalkylene oxide block copolymers, acrylic copolymers and mono- and diesters of ethylene glycol, and mixtures thereof.

Examples of anionic surfactants include alcohol sulfates, alcohol ether sulfates, alkylaryl ether sulfates, alkylaryl sulfonates such as alkylbenzene sulfonates and alkylnaphthalene sulfonates and salts thereof, alkyl sulfonates, mono- or di-phosphate esters of polyalkoxylated alkyl alcohols or alkylphenols, mono- or di-sulfosuccinate esters of C₁₂-C₁₅ alkanols or polyalkoxylated C₁₂-C₁₅ alkanols, alcohol ether carboxylates, phenolic ether carboxylates, polybasic acid esters of ethoxylated polyoxyalkylene glycols consisting of oxybutylene or the residue of tetrahydrofuran, sulfoalkylamides and salts thereof such as N-methyl-N-oleoyltaurate Na salt, polyoxyalkylene alkylphenol carboxylates, polyoxyalkylene alcohol carboxylates alkyl polyglycoside/alkenyl succinic anhydride condensation products, alkyl ester sulfates, napthalene sulfonates, naphthalene formaldehyde condensates, alkyl sulfonamides, sulfonated aliphatic polyesters, sulfate esters of styrylphenyl alkoxylates, and sulfonate esters of styrylphenyl alkoxylates and their corresponding sodium, potassium, calcium, magnesium, zinc, ammonium, alkylammonium, diethanolammonium, or triethanolammonium salts, salts of ligninsulfonic acid such as the sodium, potassium, magnesium, calcium or ammonium salt, polyarylphenol polyalkoxyether sulfates and polyarylphenol polyalkoxyether phosphates, and sulfated alkyl phenol ethoxylates, and phosphated alkyl phenol ethoxylates.

Cationic surfactants include, but are not limited to, alkanol amides of C₈-C₁₈ fatty acids and C₈-C₁₈ fatty amine polyalkoxylates, C₁₀-C₁₈ alkyldimethylbenzylammonium chlorides, coconut alkyldimethylaminoacetic acids, and phosphate esters of C₈-C₁₈ fatty amine polyalkoxylates.

Emulsifiers, which can be advantageously employed herein, can be readily determined by those skilled in the art, include various non-ionic, anionic, cationic and amphoteric emulsifiers, or a blend of two or more emulsifiers. Examples of nonionic emulsifiers useful in preparing emulsifiable concentrates, for example, include the polyalkylene glycol ethers and condensation products of alkyl and aryl phenols, aliphatic alcohols, aliphatic amines or fatty acids with ethylene oxide, propylene oxides such as the ethoxylated alkyl phenols and carboxylic esters solubilized with the polyol or polyoxyalkylene. Cationic emulsifiers include quaternary ammonium compounds and fatty amine salts. Anionic emulsifiers include the oil-soluble salts (e.g., calcium) of alkylaryl sulfonic acids, oil-soluble salts or sulfated polyglycol ethers, and salts of phosphated polyglycol ether.

In an embodiment, colorants may include, but are not limited to, iron oxide, titanium oxide and Prussian Blue, and organic dyestuffs, such as alizarin dyestuffs, azo dyestuffs, and metal phthalocyanine dyestuffs, and trace elements, such as salts of iron, manganese, boron, copper, cobalt, molybdenum, and zinc.

Exemplary thickeners and binders include, but are not limited to, molasses, granulated sugar, alginates, karaya gum, jaguar gum, tragacanth gum, polysaccharide gum, mucilage, xanthan gum or combination thereof. In another embodiment, the binder may be selected from silicates such as magnesium aluminium silicate, polyvinyl acetates, polyvinyl acetate copolymers, polyvinyl alcohols, polyvinyl alcohol copolymers, celluloses, including ethylcelluloses and methylcelluloses, hydroxymethyl celluloses, hydroxypropylcelluloses, hydroxymethylpropyl-celluloses, polyvinylpyrolidones, dextrins, malto-dextrins, polysaccharides, fats, oils, proteins, gum arabics, shellacs, vinylidene chloride, vinylidene chloride copolymers, calcium lignosulfonates, acrylic copolymers, starches, polyvinylacrylates, zeins, gelatin, carboxymethylcellulose, chitosan, polyethylene oxide, acrylimide polymers and copolymers, polyhydroxyethyl acrylate, methylacrylimide monomers, alginate, ethylcellulose, polychloroprene and syrups or mixtures thereof; polymers and copolymers of vinyl acetate, methyl cellulose, vinylidene chloride, acrylic, cellulose, polyvinylpyrrolidone and polysaccharide; polymers and copolymers of vinylidene chloride and vinyl acetate-ethylene copolymers; combinations of polyvinyl alcohol and sucrose; plasticizers such as glycerol, propylene glycol, and polyglycols.

In another embodiment, exemplary antifreeze agent(s) include comprising, but are not limited to, ethylene glycol, 1,2-propylene glycol, 1,3-propylene glycol, 1,2-butanediol, 1,3-butanediol, 1,4-butanediol, 1,4-pentanediol, 3-methyl-1,5-pentanediol, 2,3-dimethyl-2,3-butanediol, trimethylol propane, mannitol, sorbitol, glycerol, pentaerythritol, 1,4-cyclohexanedimethanol, xylenol, bisphenols such as bisphenol A or the like. In addition, ether alcohols such as diethylene glycol, triethylene glycol, tetraethylene glycol, polyoxyethylene or polyoxypropylene glycols of molecular weight up to about 4000, diethylene glycol monomethylether, diethylene glycol monoethylether, triethylene glycol monomethylether, butoxyethanol, butylene glycol monobutylether, dipentaerythritol, tripentaerythritol, tetrapentaerythritol, diglycerol, triglycerol, tetraglycerol, pentaglycerol, hexaglycerol, heptaglycerol, and octaglycerol.

According to an embodiment, exemplary biocides include, but are not limited to, benzothiazoles, 1,2-benzisothiazolin-3-one, sodium dichloro-s-triazinetrione, sodium benzoate, potassium sorbate, 1,2-phenyl-isothiazolin-3-one, and inter chloroxylenol paraoxybenzoate butyl.

According to an embodiment, antifoam agents include, but are not limited to, polydimethoxysiloxane, polydimethylsiloxane, alkyl poly acrylates, castor oil, fatty acids, fatty acid esters, fatty acid sulfates, fatty alcohols, fatty alcohol esters, fatty alcohol sulfates, olive oil, mono and di glycerides, paraffin oil, paraffin wax, polypropylene glycol, silicone oil, vegetable fats, vegetable fat sulfates, vegetable oil, vegetable oil sulfates, vegetable wax, vegetable wax sulfates, and agents based on silicon or magnesium stearate.

Exemplary additives to be used for the formulation include, for example, a solid carrier such as kaolinite, sericite, diatomaceous earth, slaked lime, calcium carbonate, talc, white carbon, kaoline, bentonite, clay, sodium carbonate, sodium bicarbonate, mirabilite, zeolite or starch; a solvent such as water, toluene, xylene, solvent naphtha, dioxane, dimethylsulfoxide, N,N-dimethylformamide, dimethylacetamide, N-methyl-2-pyrrolidone or an alcohol; an anionic surfactant such as a salt of fatty acid, a benzoate, a polycarboxylate, a salt of alkylsulfuric acid ester, an alkyl sulfate, an alkylaryl sulfate, an alkyl diglycol ether sulfate, a salt of alcohol sulfuric acid ester, an alkyl sulfonate, an alkylaryl sulfonate, an aryl sulfonate, a lignin sulfonate, an alkyldiphenylether disulfonate, a polystyrene sulfonate, a salt of alkylphosphoric acid ester, an alkylaryl phosphate, a styrylaryl phosphate, a salt of polyoxyethylene alkyl ether sulfuric acid ester, a polyoxyethylene alkylaryl ether sulfate, a salt of polyoxyethylene alkylaryl ether sulfuric acid ester, a polyoxyethylene alkyl ether phosphate, a salt of polyoxyethylene alkylaryl phosphoric acid ester, a salt of polyoxyethylene aryl ether phosphoric acid ester, a naphthalene sulfonic acid condensed with formaldehyde or a salt of alkylnaphthalene sulfonic acid condensed with formaldehyde; a nonionic surfactant such as a sorbitan fatty acid ester, a glycerin fatty acid ester, a fatty acid polyglyceride, a fatty acid alcohol polyglycol ether, acetylene glycol, acetylene alcohol, an oxyalkylene block polymer, a polyoxyethylene alkyl ether, a polyoxyethylene alkylaryl ether, a polyoxyethylene styrylaryl ether, a polyoxyethylene glycol alkyl ether, polyethylene glycol, a polyoxyethylene fatty acid ester, a polyoxyethylene sorbitan fatty acid ester, a polyoxyethylene glycerin fatty acid ester, a polyoxyethylene hydrogenated castor oil or a polyoxypropylene fatty acid ester; and a vegetable oil or mineral oil such as olive oil, kapok oil, castor oil, palm oil, camellia oil, coconut oil, sesame oil, corn oil, rice bran oil, peanut oil, cottonseed oil, soybean oil, rapeseed oil, linseed oil, tung oil or liquid paraffins. These additives may suitably be selected for use alone or in combination as a mixture of two or more of them, so long as the object of the present invention is met. Further, additives other than the above-mentioned may be suitably selected for use among those known in this field. For example, various additives commonly used, such as a filler, a thickener, an anti-settling agent, an anti-freezing agent, a dispersion stabilizer, a safener, an anti-mold agent, a bubble agent, a disintegrator and a binder, may be employed.

The agrochemical formulations may also comprise one or more antioxidants. Preferably, the agrochemical formulation comprises an antioxidant. Exemplary antioxidants are, for example, amino acids (e.g., glycine, histidine, tyrosine, tryptophan) and derivatives thereof, imidazole and imidazole derivatives (e.g., urocanic acid), peptides, such as, for example, D,L-carnosine, D-carnosine, L-carnosine and derivatives thereof (e.g., anserine), carotenoids, carotenes (e.g., α-carotene, β-carotene, lycopene) and derivatives thereof, lipoic acid and derivatives thereof (e.g., dihydrolipoic acid), aurothioglucose, propylthiouracil and further thio compounds (e.g., thioglycerol, thiosorbitol, thioglycolic acid, thioredoxin, glutathione, cysteine, cystine, cystamine and the glycosyl, N-acetyl, methyl, ethyl, propyl, amyl, butyl, lauryl, palmitoyl, oleyl, γ-linoleyl, cholesteryl and glyceryl esters thereof), and salts thereof, dilauryl thiodipropionate, distearyl thiodipropionate, thiodipropionic acid and derivatives thereof (esters, ethers, peptides, lipids, nucleotides, nucleosides and salts), and sulfoximine compounds (e.g. buthionine sulfoximines, homocysteine sulfoximine, buthionine sulfones, penta-, hexa-, heptathionine sulfoximine) in very low tolerated doses, also metal chelating agents (e.g. α-hydroxy fatty acids, ethylenediaminetetraacetic acid (EDTA), ethylene glycol-bis(β-aminoether)-N,N,N′,N′-tetraacetic acid (EGTA), phytic acid, lactoferrin), α-hydroxy acids (e.g. citric acid, lactic acid, malic acid), humic acids, bile acid, bile extracts, gallic esters (e.g. propyl, octyl and dodecyl gallate), flavonoids, catechins, bilirubin, biliverdin and derivatives thereof, unsaturated fatty acids and derivatives thereof (e.g. γ-linolenic acid, linoleic acid, arachidonic acid, oleic acid), folic acid and derivatives thereof, hydroquinone and derivatives thereof (e.g. arbutin), ubiquinone and ubiquinol, and derivatives thereof, vitamin C and derivatives thereof (e.g. ascorbyl palmitate, stearate, dipalmitate, acetate, magnesium ascorbyl phosphates, sodium and magnesium ascorbate, disodium ascorbyl phosphate and sulfate, potassium ascorbyl tocopheryl phosphate, chitosan ascorbate), isoascorbic acid and derivatives thereof, tocopherols and derivatives thereof (e.g., tocopheryl acetate, linoleate, oleate and succinate, tocophereth-5, tocophereth-10, tocophereth-12, tocophereth-18, tocophereth-50, tocophersolan), vitamin A and derivatives (e.g., vitamin A palmitate), the coniferyl benzoate of benzoin resin, rutin, rutinic acid and derivatives thereof, disodium rutinyl disulfate, cinnamic acid and derivatives thereof (e.g., ferulic acid, ethyl ferulate, caffeeic acid), kojic acid, chitosan glycolate and salicylate, butylhydroxytoluene, butylhydroxyanisol, nordihydroguaiacic acid, nordihydroguaiaretic acid, trihydroxybutyrophenone, uric acid and derivatives thereof, mannose and derivatives thereof, selenium and selenium derivatives (e.g. selenomethionine), stilbenes and stilbene derivatives (e.g., stilbene oxide, trans-stilbene oxide). According to the invention, suitable derivatives (salts, esters, sugars, nucleotides, nucleosides, peptides and lipids) and mixtures of these specified active ingredients or plant extracts (e.g., teatree oil, rosemary extract and rosemarinic acid) which comprise these antioxidants can be used. In general, mixtures of the aforementioned antioxidants are possible.

According to an embodiment, examples of solvents include, but are not limited to, water, aromatic solvents (for example, xylene), paraffins (for example mineral oil fractions such as kerosene or diesel oil), coal tar oils and oils of vegetable or animal origin, aliphatic, cyclic and aromatic hydrocarbons, for example toluene, xylene, paraffin, tetrahydronaphthalene, alkylated naphthalenes or their derivatives, alcohols (for example, methanol, butanol, pentanol, benzyl alcohol, cyclohexanol), ketones (for example, cyclohexanone, gamma-butyrolactone), pyrrolidones (NMP, NEP, NOP), acetates (glycol diacetate), glycols, fatty acid dimethylamides, fatty acids and fatty acid esters, isophorone and dimethylsulfoxide. In principle, solvent mixtures may also be used.

According to an embodiment, examples of carriers include, but are not limited to, mineral earths such as silica gels, silicates, talc, kaolin, attaclay, attapulgite, limestone, lime, chalk, bole, loess, clay, dolomite, diatomaceous earth, calcium sulfate, magnesium sulfate, magnesium oxide, ground synthetic materials, fertilizers, such as, for example, ammonium sulfate, ammonium phosphate, ammonium nitrate, ureas, and products of vegetable origin, such as cereal meal, tree bark meal, wood meal and nutshell meal, cellulose powders, polyvinylpyrrolidone and other solid carriers.

Exemplary preservatives include, for example, 1,2-benzisothiazolin-3-one and/or 2-methyl-2H-isothiazol-3-one or sodium benzoate or benzoic acid.

The herbicidal combinations and compositions of the present disclosure can be in any conventional agriculturally useful form, for example, in the form of a ready-to-use formulation, or in the form of a tank mix.

### ADVANTAGES OF THE PRESENT INVENTION

1. The present invention provides highly pure glufosinate ammonium substantially free of inorganic salts
2. The present invention further provides process for preparation of highly pure glufosinate ammonium substantially free of inorganic salts
3. Said process provides separation of glufosinate ammonium from inorganic salts avoiding multiple purification steps
4. Said process is industrially viable and environmentally friendly process for separation of glufosinate ammonium from inorganic salts

### EXAMPLES

The instant invention is more specifically explained by below examples. However, it should be understood that the scope of the present invention is not limited by the examples in any manner. It will be appreciated by any person skilled in this art that the present invention includes below examples and further can be modified and altered within the technical scope of the present invention.

### Analytical Method Details:

HPLC method: Samples were analysed on high performance liquid chromatograph with UV detector using Inertsil—ph 3 (250×4.6 mm i.d., 5 micron) column.

### Example 1: Process for Preparing Racemic Glufosinate Ammonium

107 kg hydrolysed reaction mass comprising glufosinate hydrochloride and inorganic salts, obtained according to example 3 of U.S. Pat. No. 4,264,532 by reaction of 3-[ethoxy(methyl)phosphoryl]propanal with potassium cyanide and ammonium chloride followed by hydrolysis, was diluted with 350 kg of water and then neutralised using aqueous ammonia to obtain first solution having total dissolved solute content below 9%. Said first solution was passed through nano-filtration membrane The biotech element D-Series Thin-Film Membrane (TFM*) nanofiltration membrane. The solution was filtered through membrane at 20° C.-50° C. by maintaining trans-membrane pressure of about 14 bar to 38 bar to obtain 111 kg of the second solution and 250 kg of the permeate. The second solution was then subjected to distillation under vacuum to distil out 80%-90% water to get reaction mass. To this reaction mass was added 38.9 kg of methanol and mixture was refluxed for 1 hour at 75-80° C. The reaction mixture was then cooled to 40-45° C. and ammonia gas was purged into the mixture till pH was 9-10. The mixture was then cooled to 5-10° C. to obtain precipitate of glufosinate ammonium. The product was then filtered, washed with methanol and dried to get 10.7 kg of glufosinate ammonium having wt/wt purity of >96% (inorganic salt content=<2% 0).

### Example 2: Process for Preparing L-Glufosinate Ammonium

### Step 1: Preparation of Ethyl(2S)-2-[(ethoxycarbonyl)amino]-4-(ethoxymethylphosphinyl)butanoate

550 g (1 mole equivalent) of ethyl(2S)-4-chloro-2-[(ethoxy carbonyl)amino]-butanoate and 490 g (1.5 moles equivalent) of Diethyl methyl phosphonite were charged to a reaction flask at 25-30° C. The mixture was heated at 140° C. for 20 hours while flushing with Nitrogen continuously in the system. After completion of the reaction, the excess diethyl methylphosphonite was distilled off under vacuum to get crude Ethyl(2S)-2-[(ethoxycarbonyl)amino]-4-(ethoxymethylphosphinyl)butanoate.

### Step 2: Preparation of Hydrolysed Mass

To 618 g of crude Ethyl(2S)-2-[(ethoxycarbonyl)amino]-4-(ethoxymethylphosphinyl) butanoate was added 2579 g of conc. HCl (30% concentration) and the mixture was refluxed for 16 hours. The mixture obtained was subjected to distillation to obtain 1612 g of hydrolysed reaction mass.

### Step 3: Preparation of L-Glufosinate Ammonium

To the hydrolysed mass obtained in step 2 was added 1000 g of water and pH was adjusted to 7.1 by purging ammonia gas. Said mixture was then diluted with 5300 g of water to get first solution having total dissolved solute content below 8%. Said first solution was passed through nano-filtration membrane (for this experiment—The biotech element D-Series Thin-Film Membrane (TFM*) nanofiltration membrane was used). The solution was filtered through membrane at 20° C. to 50° C. temperature by maintaining trans-membrane pressure of about 10 bar to 20 bar to obtain 3830 g of the second solution and 3549 g of permeate. The second solution was then subjected to vacuum distillation to distil out 80%-90% water to get reaction mass. To this reaction mass was added 996 g of methanol and mixture was refluxed for 2 hours. The mixture was then cooled to 30-40° C. and ammonia gas was purged into the mixture till pH was 8-10. The temperature was then increased to 60-70° C. for 2 hours and then cooled to 5-10° C. to obtain precipitate of L-glufosinate ammonium. The product was then filtered, washed with methanol and dried to get 300 g of L-glufosinate ammonium having % wt/wt purity of 96.4% (inorganic salt content=0.3%) Chiral ratio of 98:02 (L:D).

1. A process for preparing glufosinate ammonium having less than 3% by weight of inorganic salts, said process comprising precipitating glufosinate ammonium by treating a solution comprising glufosinate with ammonia, said solution comprising glufosinate being prepared by passing a first solution comprising glufosinate and inorganic salts through a membrane.

2. The process for preparing glufosinate ammonium as claimed in claim 1, comprising:
a) processing a first solution comprising of glufosinate and inorganic salts through a membrane to obtain a second solution and a permeate; and
b) precipitating glufosinate ammonium from said second solution by ammonia treatment;
wherein said glufosinate ammonium contains less than 3% by weight of inorganic salts.

3. The process as claimed in claim 2, wherein in step a) glufosinate used is racemic glufosinate or L-glufosinate.

4. The process as claimed in claim 2, wherein the first solution comprising glufosinate and inorganic salts obtained from a hydrolysed reaction mass comprising glufosinate hydrochloride and inorganic salts.

5. The process as claimed in claim 4, wherein the hydrolysed reaction mass is subjected to
i) adjusting the total dissolved solute concentration below 15% and
ii) adjusting pH value in the range of 6 to 8
to obtain the first solution comprising of glufosinate and inorganic salts.

6. The process as claimed in claim 5, wherein in the step i) the total dissolved solute concentration is adjusted by diluting hydrolysed reaction mass with water and in step ii) pH value is adjusted using a base.

7. The process as claimed in claim 5, wherein the steps i) and ii) are carried out in any sequence.

8. The process as claimed in claim 6, wherein said base is selected from ammonia, ammonium hydroxide, hydroxides of alkali metal or alkali earth metal, carbonates of alkali metal or alkali earth metal, alcohol salts of alkali metal or alkali earth metal.

9. The process as claimed in claim 4, wherein the first solution comprises from about 1% to about 7% by weight of glufosinate and about 2% to about 12% by weight of inorganic salts.

10. The process as claimed in claim 1, wherein the membrane used in step a) is a nano-filtration membrane made of polymeric material selected from group comprising of polyamide, polyethylene, polypropylene, polytet rafluoroethylene, polyvinylidene difluoride, polysulfone, polyethersulfone, polyacrylonitrile, polyimide, polyamideimide, polyetherimide, cellulose acetate, polyaniline, polypyrrole, polyetheretherketone, polybenzimidazole, polyester, vinyl polymer or mixtures thereof.

11. The process as claimed in claim 9, wherein the nano-filtration membrane having molecular weight in the range of about 100 unit Da to about 200 unit Da.

12. The process as claimed in claim 1, wherein the first solution is processed through a membrane at a trans-membrane pressure ranging from about 3 (g) bar to about 50 (g) bar.

13. The process as claimed in claim 1, wherein the glufosinate ammonium obtained has purity of about more than 95% by HPLC.

14. A process for preparing glufosinate ammonium or L-glufosinate ammonium comprising the steps of:
a) preparing a first solution comprising glufosinate or L-glufosinate and inorganic salts having total dissolved solute content below 15%;
b) processing said first solution through a membrane to obtain a second solution and permeate; and
c) precipitating glufosinate ammonium or L-glufosinate ammonium from the second solution by ammonia treatment comprising; wherein said glufosinate ammonium or L-glufosinate ammonium contains less than 3% by weight of inorganic salts.

15. (canceled)

16. Glufosinate ammonium or L-glufosinate ammonium having less than 3% by weight of an inorganic salt.

17. (canceled)

18. An herbicide composition comprising the glufosinate ammonium or L-glufosinate ammonium having less than 3% by weight of an inorganic salt of claim 16 and at least one agrochemically acceptable excipient.
